(19) United States
(12) Patent Application Publication
(10) Pub. No.: US 2006/0044261 A1
(43) Pub. Date: Mar. 2, 2006

(54) Pointing input device imitating inputting of hotkeys of a keyboard

(76) Inventor: Kao-Cheng Hsieh, Taipei (TW)

Correspondence Address: G. LINK CO., LTD., PmB 174, 931 West 75th Street, Suite 137, Naperville, IL, 60565, US

(21) Appl. No.: 10/932,049

(22) Filed: Sep. 2, 2004

(51) Int. Cl. G09G 5/00

(52) U.S. Cl. 345/156

(57) ABSTRACT

The pointing input device includes: keys to generate key variation signals, a displacement generating means to generate displacement signals, a controller connecting the keys and the displacement generating means to receive the key variation signals and the displacement signals. The device is characterized by that: when the pointing input device is in a first working mode, the controller receives the key variation signals and the displacement signals and converts them into corresponding pointing data signals; and when the pointing input device is in a second working mode, the controller converts the key variation signals and the displacement signals into corresponding hotkey signals of a keyboard according to the direction and the speed of displacement of the key variation signals and the displacement signals.

### FIELD OF THE INVENTION

The present invention is related to a pointing input device, and especially to a pointing input device capable of imitating inputting of hotkeys of a keyboard.

### BACKGROUND OF THE INVENTION

Hotkey functions provided by a conventional mouse display an icon of a plurality of hotkeys on a display of a computer, the mouse is used to select by clicking the desired icon to make the computer execute the function corresponding to the icon. However, this mode has a defect mainly resided in that the computer must be installed with a driving program used in cooperation with the mouse, otherwise, the computer will be unable to display the icon of these hotkeys, and unable to allow a user to select the icon by clicking. And more, the screen frame displayed by the hotkeys of the icon often destroys the originally displayed screen frame to make a mess of the whole screen; and even when the computer plays a VCD for enjoyment, destroy of the whole screen induced by the screen frame displayed by the hotkeys of the icon always makes the user sick.

A U.S. Pat. No. 6,515,686B1 titled “Computer system for interface of shell program and interface method of the same” discloses that a roller key or a key of a mouse is used to activate the shell program, then the roller key is moved upwardly or downwardly to select one among a plurality of application programs of the shell program for executing registration. The U.S. Pat. No. 6,515,686B1 still shall have installation of the shell program completed on the computer before using hotkeys in cooperation with the mouse; and more, by the fact that the shell program displays an icon representing an application program displayed on a screen, the originally displayed screen frame is inevitably destroyed.

By virtue of wide application of the operation system of the window environment, every conventional keyboard is provided with a plurality of hotkeys, and the manufacturer (such as the Microsoft Company of the U.S.A.) of the window operation system also provides a standard specification for the hotkeys of a keyboard, and the functions of the hotkeys are directly built in the operation system, there is no necessity of a conventional installation and execution mode in cooperation with a specific driving program of the keyboard, a user can directly press down the hotkeys of the keyboard to execute corresponding functions immediately. Such a human-machine interface brings extreme great convenience. However, the convenience is only limited to the keyboard, a conventional mouse is unable to provide such a convenient function.

In view of the above defects to be solved pressingly of the prior art, the inventor of the present invention provides a pointing input device capable of imitating inputting of hotkeys of a keyboard to render a user of a mouse to directly use the mouse to output outputting results corresponding to the hotkeys of the keyboard to a computer.

### SUMMARY OF THE INVENTION

The main object of the present invention is to provide a pointing input device capable of imitating inputting of hotkeys of a keyboard to render a user of a mouse to directly use the mouse to output outputting results corresponding to the hotkeys of the keyboard to a computer.

To get the abovementioned object, the present invention provides a pointing input device capable of imitating inputting of hotkeys of a keyboard; the device includes a plurality of keys to generate key variation signals, a displacement generating means to generate displacement signals; a controller connecting a plurality of keys and the displacement generating means to receive the key variation signals and the displacement signals. The present invention is characterized by that: when the pointing input device is in a first working mode, the controller receives the key variation signals and the displacement signals and converts them into corresponding index data signals; and when the pointing input device is in a second working mode, the controller converts the key variation signals and the displacement signals into corresponding hotkey signals of a keyboard according to the direction and the speed of displacement of the key variation signals and the displacement signals.

The present invention will be apparent in its objects, features and functions for those skilled in this art after reading the detailed description of the preferred embodiment thereof in reference to the accompanying drawings.

### BRIEF DESCRIPTION OF THE DRAWINGS

The present invention can be more fully understood by reference to the following description and accompanying drawings, in which:

FIG. 1 is a schematic view showing the hardware arrangement of the present invention; and

FIG. 2 is a flow chart of the execution process of a controller.

### DETAILED DESCRIPTION OF THE INVENTION

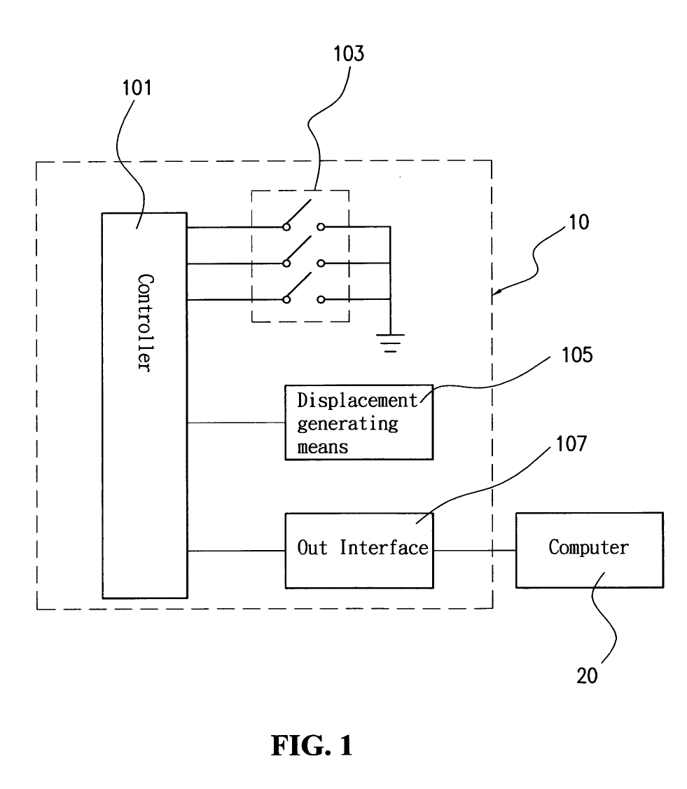

FIG. 1 is a schematic view showing a hardware arrangement of the present invention, wherein a pointing input device 10 capable of imitating inputting of hotkeys of a keyboard of the present invention comprises mainly: a plurality of keys 103, a displacement generating means 105 and a controller 101. The keys 103 are used to generate key variation signals, a user can press and release the keys 103 to generate these variation signals, namely, to generate voltage variation signals 0 and 1. The displacement generating means 105 is used to generate displacement signals, taking a mouse as an example, an embodiment of the displacement generating means 105 can be a coding circuit for an X axis displacement and a Y axis displacement, when a user moves the pointing input device 10, the displacement generating means 105 generates displacement signals according to the direction and the speed of displacement of the pointing input device 10. The controller 101 electrically connects a plurality of keys 103 and the displacement generating means 105 to receive the key variation signals and the displacement signals. And more, an output interface 107 of the present invention is used to connect a computer 20, taking a cable mouse as an example, the output interface 107 can be a USB engine circuit used to envelop the data transmitted from the controller 101 to form a USB envelope, then to transmit the USB envelope through a USB cable to the computer 20.

The main feature of the pointing input device 10 of the present invention is to provide a user with two working modes for use and operation. The pointing input device 10 in the first working mode mainly is to provide the pointing input device 10 with its original pointing control function, taking a mouse as an example, the first working mode of the present invention works exactly in the mode of a normal mouse for the user to operate pointing function; while the controller 101 receives the key variation signals and the displacement signals and converts them into corresponding pointing data signals. When the pointing input device 10 is switched from the first working mode to the second working mode, the mouse immediately imitates a keyboard rather than executing the function of the normal mouse; at this time, the user can operate in the way as usual in operating the normal mouse to input in substituting for the inputting by the hotkey operation of a keyboard. From a viewpoint of the user, he operates the mouse in substitution for direct keying in of the hotkeys of the keyboard.

The present invention mainly takes advantages of the features of the pointing input device 10 and changes the features into particular technical measures to apply them on the input functions imitating the functions of a keyboard. The pointing input device 10 at least has the features in relation to the direction and the speed of displacement of the displacement signals, and at least has a plurality of keys 103. Taking a mouse as an example, the particular style of the keys 103 include a left key, a middle key and a right key. The controller 101 of the present invention can combine the direction and the speed of displacement of the displacement signals and the variation signals of the keys 103 under the second working mode to imitate the functions in corresponding to those of different hotkeys of a keyboard. Taking the mouse having the left key, the middle key and the right key as an example, the mouse is applied on fast control of playing of multimedia, and the mouse provides the following functions in the second working mode: displacement of upward displacing induced by upward moving of the mouse corresponds to imitation of an upper first hotkey of the keyboard; displacement of downward displacing induced by downward moving of the mouse corresponds to imitation of a lower first hotkey of the keyboard; displacement of rightward displacing induced by rightward moving of the mouse corresponds to imitation of a fast forwarding hotkey of the keyboard; displacement of leftward displacing induced by leftward moving of the mouse corresponds to imitation of a rewinding hotkey of the keyboard; variation signals obtained by pressing the left key corresponds to imitation of a playing hotkey of the keyboard; variation signals obtained by pressing the middle key corresponds to imitation of a pause hotkey of the keyboard; variation signals obtained by pressing the right key corresponds to imitation of a stop hotkey of the keyboard.

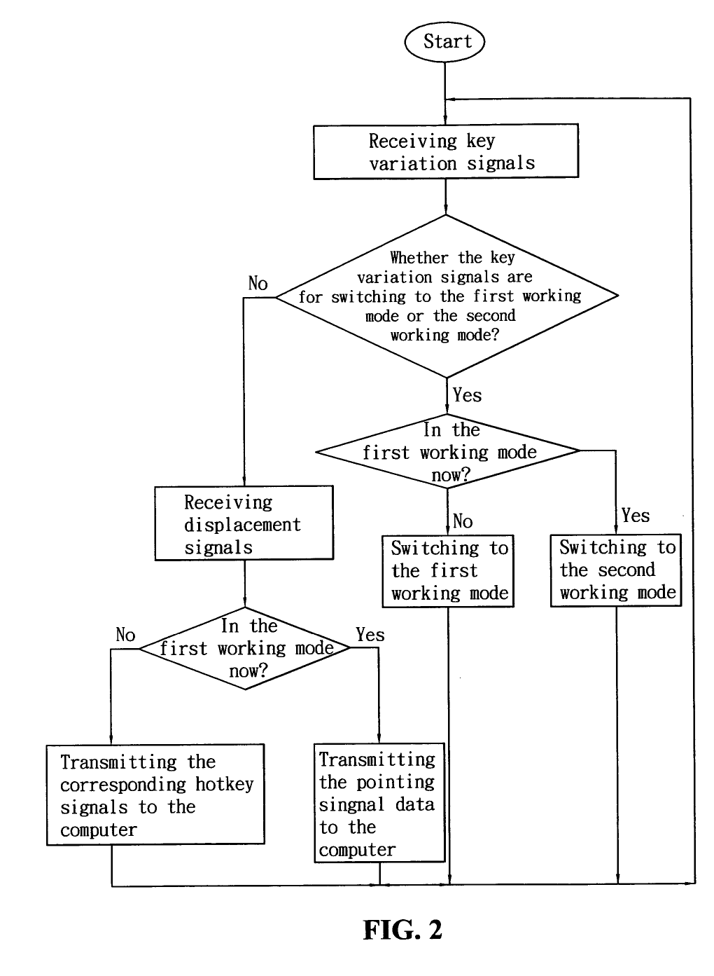

FIG. 2 is a flow chart of the execution process of the controller 101. The controller 101 decides whether the variation signals received from and generated by the keys 103 are switching signals for switching to the first working mode or the second working mode, if they are switching signals, switching to one of the working modes is performed, and then the process gets back to the process of receiving the key variation signals. If they are not switching signals, the process of receiving the displacement signals is performed; then the key variation signals and the displacement signals are processed according to the working mode that the pointing input device 10 is in it now. If the pointing input device 10 is in the first working mode now, the controller 101 converts the received key variation signals and displacement signals into corresponding hotkey signals of the keyboard; for a mouse, the signals generated by the left key, the middle key and the right key or by index displacement operation are used as index data signals. If the pointing input device 10 is in the second working mode now, the controller 101 converts the key variation signals and the displacement signals received into corresponding hotkey signals of the keyboard; for a mouse, the signals generated by the left key, the middle key and the right key or by index displacement operation are used as hotkey signals imitating the functions of a keyboard. The pointing input device 10 of the present invention further comprises a switching means for switching to the first working mode and the second working mode; taking the mouse as an example, a practical measure for practicing the switching means can be that, the controller 101 switches the working mode of the pointing input device 10 according to key variation signals received. For example, to press simultaneously the left key and the right key, then repeatedly press and release the middle key trice to generate key variation signals to act as the switching means; alternatively, to press an added mode switching key 103a to generate key variation signals to act as the switching means.

Moreover, when the pointing input device 10 of the present invention is in the second working mode, to further assure that the generated key variation signals and displacement signals are not error signals (such as the error signals of displacement signals generated when the user inadvertently moves the pointing input device 10), the present invention can use an added input key 103b in order that when the user presses the input key 103b and keeps the pressing state, the key variation signals and displacement signals can then be received by the pointing input device 10.

The embodiment of the pointing input device 10 of the present invention can, in addition to the abovementioned mouse, be an input device such as a trackball, a joystick etc.

The corresponding hotkey signals of the keyboard generated when the pointing input device 10 of the present invention is in the second working mode can be transmitted to the computer 20 via the abovementioned output interface 107, and the corresponding hotkey signals of the keyboard for example can be enveloped to form a USB keyboard envelope by the USB engine circuit. As for the computer 20, it will deem that it receives a USB keyboard envelope transmitted from the keyboard. The pointing input device 10 of the present invention can imitate the input of hotkeys of the keyboard following this way, thereby, the above stated corresponding hotkey signals of the keyboard particularly in practice can be a kind of scan code signal of the corresponding hotkeys of the keyboard.

The pointing input device 10 of the present invention can be used as a normal pointing input device, and can further be used for imitating inputting of hotkeys of a keyboard. Those skilled in this art can easily get and enlarge the amount of the hotkeys for imitating a keyboard, for example, the above stated displacements in four directions can be enlarged to make variations in eight directions; and the speed of the displacements, i.e., the total amount of the displacement signals within a predetermined time, is also a feature of the pointing input device 10. Combinations of the features owned by the pointing input device 10 can be enlarged to make variations to get more amount of imitating hotkeys, all such changes shall fall within the scope of the appended claims.

It will be apparent to those skilled in this art that various modifications and changes can be made to the present invention without departing from the spirit and conception of this invention; and all such equivalent modifications and changes shall fall within the scope of the appended claims.

What is claimed is:

1. A pointing input device capable of imitating inputting of hotkeys of a keyboard, said pointing input device comprises:
a plurality of keys to generate key variation signals;
a displacement generating means to generate displacement signals;
a controller connecting a plurality of keys and said displacement generating means to receive said key variation signals and said displacement signals;
said pointing input device is characterized by that: when said pointing input device is in a first working mode, said controller receives said key variation signals and said displacement signals and converts them into corresponding pointing data signals; and when said pointing input device is in a second working mode, said controller converts said key variation signals and said displacement signals into corresponding hotkey signals of a keyboard according to direction and speed of displacement of said key variation signals and said displacement signals.

2. The pointing input device as in claim 1, wherein said pointing input device is one of a mouse, a trackball and a joystick.

3. The pointing input device as in claim 1, wherein said keys are respectively a left key, a middle key and a right key.

4. The pointing input device as in claim 1, wherein said controller is used to switch working mode of said pointing input device according to said key variation signals received.

5. The pointing input device as in claim 4, wherein said keys are combinations of a left key, a middle key and a right key.

6. The pointing input device as in claim 4, wherein said keys include a mode switching key.

7. The pointing input device as in claim 1, wherein said pointing input device further comprises: an input key to assure that said key variation signals and said displacement signals are variation signals for switching to said second working mode.

8. The pointing input device as in claim 1, wherein said corresponding hotkey signals of said keyboard are of a kind of scan code signal of said corresponding hotkeys of said keyboard.

9. The pointing input device as in claim 1, wherein displacing directions of said displacement signals are respectively upward, downward, rightward and leftward directions.

10. The pointing input device as in claim 1, wherein said speed of displacement of said displacement signals is a total amount of said displacement signals within a predetermined time.
